(19) United States
(12) Patent Application Publication
(10) Pub. No.: US 2019/0337401 A1
(43) Pub. Date: Nov. 7, 2019

(54) BATTERY SYSTEM AND ELECTRICALLY DRIVABLE MOTOR VEHICLE

(71) Applicant: FORD GLOBAL TECHNOLOGIES, LLC, Dearborn, MI (US)

(72) Inventors: Moritz Klaus SPRINGER, Hagen NRW (DE); Martin Christoph LUTZ, Cologne NRW (DE); Christian HOFMANN, Pulheim NRW (DE); Michael Peter LOEFFLER, Bergisch Gladbach NRW (DE); Fabian KUEPPERS, Bornheim NRW (DE)

(73) Assignee: FORD GLOBAL TECHNOLOGIES, LLC, Dearborn, MI (US)

(21) Appl. No.: 16/403,143

(22) Filed: May 3, 2019

(30) Foreign Application Priority Data
May 3, 2018 (DE) 102018206827.5

(51) Int. Cl. B60L 50/60; B60L 58/12; B60L 58/21; B60L 50/64; H01M 10/42

(52) U.S. Cl. CPC B60L 50/66; B60L 58/12; H01M 10/425; B60L 50/64; B60L 58/21

(57) ABSTRACT

A battery system for an electrically drivable vehicle includes at least one set of battery electronics that delivers a battery voltage, and at least one rechargeable traction battery connected to an input of the set of battery electronics, the traction battery configured for connection to at least one supplementary traction battery connectable in series or parallel to enable the traction battery capacity and/or life to be extended. The battery system may include a traction battery housing having a main compartment configured to receive the traction battery and at least one supplemental compartment configured to receive a modular supplemental traction battery.

### CROSS-REFERENCE TO RELATED APPLICATIONS

This application claims foreign priority benefits under 35 U.S.C. § 119(a)-(d) to DE Application 10 2018 206 827.5 filed May 3, 2018, which is hereby incorporated by reference in its entirety.

### TECHNICAL FIELD

The invention relates to a battery system for an electrically drivable motor vehicle, having at least one set of battery electronics, which delivers a battery voltage, and at least one rechargeable traction battery, which is connected to an input of the set of battery electronics. Furthermore, the invention relates to an electrically drivable motor vehicle, having at least one electric traction motor and at least one battery system connected to the electric traction motor, for supplying the electric traction motor with electrical energy.

### BACKGROUND

Electrically drivable motor vehicles such as, for example, electric vehicles and hybrid electric vehicles, each have a traction battery by which the electrical drive means of the motor vehicle are supplied with electrical energy while the motor vehicle is in electrical driving mode.

During charging and discharging, traction batteries are subjected to powerful transition processes. Strong electrical charging currents and discharging currents, which alternate with a large depth of discharge, in this case cause a deterioration of the battery power and battery capacity over the service life of the traction battery, in particular in the case of a lithium-ion traction battery. Correspondingly deteriorated traction batteries, in turn, result in a reduced power of a drive system of an electrically drivable motor vehicle. For example, a recuperation potential is reduced, which, in the case of a hybrid electric vehicle having an internal combustion engine, results in an increased fuel consumption. Moreover, as battery power deteriorates, or battery capacity is reduced, functionalities that are supported by the battery power may be limited. The battery power and capacity are thus essential for specific vehicle functionalities, for which reason it is absolutely necessary to ensure that the battery supports the specified vehicle functions in all circumstances. For this reason, a traction battery is usually over-rated by a certain amount in order to take account of a defined battery wear. The battery power of a traction battery is monitored and, when the battery power exceeds a certain deterioration, conventionally the traction battery is exchanged for a new traction battery during a vehicle service.

Deteriorated traction batteries are basically still usable, but are no longer usable in a highly transient vehicle environment. Instead, in order to maintain the total power of an electrical drive system of a motor vehicle, the traction battery must be exchanged for a new traction battery, which can be very cost-intensive, depending on the costs of the specific traction battery. In the case of a conventional lithium-ion traction battery, for a vehicle owner the costs for a new traction battery are very high.

U.S. Pat. No. 9,457,684 B2 discloses a system, having a first battery, which is configured to power at least one vehicle sub-system, and a second battery, which is configured to power an electric motor, in order to drive a vehicle, and having a processing means, which is configured to detect an inadequate power level delivered by the first battery to the at least one vehicle sub-system, and to selectively partition the second battery in order to power the at least one vehicle sub-system.

US 2012/0032630 A1 discloses a battery jump method without an own energy supply, which uses the generator of a vehicle to charge main and replacement batteries during the operation of the vehicle. When the main battery loses its power, the replacement battery supplies electric current to the main battery and to the vehicle engine in order to start the vehicle whenever required without external electricity. Manual, semiautomatic and automated jump modes are available.

US 2017/0072811 A1 discloses a vehicle, having a traction battery set comprising a high-voltage bus and a plurality of individual battery cells, the traction battery set having a plurality of internal circuits that provide a plurality of corresponding, independent internal measurements of a voltage of the traction battery set. Furthermore, the vehicle has a plurality of external circuits, which are external to the traction battery set and coupled to the high-voltage bus, and which provide a plurality of corresponding, independent external measurements of the voltage of the traction battery set. Furthermore, the vehicle has an electric machine, which is operated by the traction battery set via one of the plurality of external circuits, in order to drive the vehicle, and a controller, which communicates with the plurality of internal circuits and the plurality of external circuits, and which is programmed to transmit a battery-set voltage to a vehicle network, the battery-set voltage corresponding to a first independent, internal measurement as a reaction to the fact that a voltage difference, among all independent, internal measurements, is less than a threshold value, to a second independent, internal measurement as a reaction to the fact that the voltage difference exceeds the threshold value, and to a statistical measure of the independent, internal and external measurements as a reaction to the fact that any one of the internal measurements is invalid.

U.S. Pat. No. 9,450,274 B2 discloses a method and a device for generating a dynamically reconfigurable energy source, which is composed of individual, insulated, controllable energy modules, supported by software for measuring and managing the energy modules and enabling the reconfiguration. The platform is composed of hardware, which is based on an inverted H-bridge circuit, in combination with software that allows real-time management, control and configuration of the modules, and that uses a combination of software algorithms and localized electronic switches.

U.S. Pat. No. 8,381,851 B2 discloses a method for operating a series hybrid vehicle, in which an internal combustion engine generates a secondary power that is either stored or used as direct input energy by a secondary energy source, in order to supply drive energy to the vehicle. Regenerative braking is used to convert kinetic energy of the vehicle into secondary energy, which is likewise stored. When the vehicle driver makes a power demand, the secondary energy source is operated by secondary energy from an energy storage device, direct input energy generated by the internal combustion engine, or both, depending on the amount of stored secondary energy in combination with the vehicle speed. When in use, the power level at which the internal combustion engine is operated is likewise determined on the basis of available stored energy and the vehicle speed. At higher vehicle speeds, the amount of stored energy is allowed to be depleted in order to increase the available storage capacity for regenerative braking.

U.S. Pat. No. 9,487,103 B2 discloses a battery management method for managing a supplementary battery module and a main battery module of a hybrid vehicle. A non-volatile memory is read, by means of a battery management processor, to determine whether the non-volatile memory contains data indicating a voltage drop in the supplementary battery module. By means of the battery management processor, at least one input signal from at least one voltage-drop detector of at least one smart device, which has a device processor, determines a voltage drop condition in the at least one smart device, the at least one smart device being configured to receive electrical energy from the supplementary battery module. By means of the battery management processor, it is determined that a triggering even has occurred if the non-volatile memory contains data indicating a voltage drop in the supplementary battery module, or the at least one smart device exhibits the voltage-drop condition. By means of the battery management processor, the main battery module is instructed to electrically charge the supplementary battery module of the hybrid vehicle if the triggering event has occurred.

US 2017/0158062 A1 discloses a vehicle electrical power distribution system having a battery, which has a nominal voltage, a load, which has a rated voltage that is less than the nominal voltage, and a relay, which has an electric circuit for converting the nominal voltage down to the rated voltage, and an output, which is configured to selectively supply the load with the rated voltage in reaction to a control signal applied to an input of the relay.

WO 2017/005355 A1 discloses an integrated and starter and on-board electrical system module for connection to a starter battery and to an on-board electrical system comprising a converter, wherein the converter can be connected to a starter circuit comprising the starter battery, via a starter controller and via an on-board electrical system disconnector. The on-board electrical system can be decoupled from the starter circuit, and the starter control and the on-board electrical system disconnector are integrated in the module.

The publication available from the link http://www.yuasa.co.uk/info/technical/auxiliary-back-batteries-explained/discloses an auxiliary battery for a hybrid vehicle, which is not used to supply the electric traction motors with electrical energy.

The publication available from the link https://www.utc.edu/college-engineering-computer-science/re-search-centers/cete/hybrid.php discloses advantages of hybrid vehicles in comparison with conventional vehicles.

The publication available from the link http://ieeexplore.ieee.org/document/5522497 discloses a combination of a traction battery of a hybrid vehicle and a supercapacitor.

### SUMMARY

Embodiments according to the disclosure may provide various advantages, such as enabling a traction battery to be used over its entire service life in an electrically drivable motor vehicle, without impairing the operation of the motor vehicle. Similarly, a battery system capacity may be increased by combining one or more modular supplementary traction batteries with a main traction battery.

In one or more embodiments, a battery system includes at least one supplementary traction battery, which is connected in parallel or in series with the traction battery, or which is connected to a further input of a set of battery electronics.

It must be pointed out that the features and measures that are mentioned individually in the following description may be combined with each other in any technically appropriate manner and show further embodiments of the invention. The description additionally characterizes and specifies embodiments of the disclosure in connection with the figures.

According to one or more embodiments of the disclosure, an electrically drivable motor vehicle can first be equipped and operated using only the traction battery, without the supplementary traction battery being installed in the motor vehicle. If the set of battery electronics or another set of vehicle electronics of the battery system thus conventionally formed has deteriorated by a predefined amount, the respective electronics can generate and output a signal that indicates to a vehicle owner (or in the vehicle memory, which is read-out during vehicle servicing) that the supplementary traction battery should additionally be installed in the motor vehicle in order to compensate the deterioration of the traction battery, such that the correspondingly supplemented battery system again reliably fulfils the original demands on the battery system.

In contrast to a conventionally required complete replacement of the deteriorated traction battery with a new traction battery, according to embodiments of the disclosure the traction battery can remain installed in the motor vehicle and continue to be used over its entire service life. It is necessary only for the supplementary traction battery to be procured and installed, which is significantly less expensive than the conventional replacement of the traction battery, particularly in the case of a supplementary traction battery that is smaller than the traction battery and/or has a lesser electrical capacity than the traction battery.

Use of a modular supplemental traction battery according to one or more embodiments, provides the possibility for the primary traction battery to be rated with a lesser inherent redundancy, or a lesser operational margin, or to be designed with a lesser over-rating, since the battery power of the battery system can easily be restored if the demand on the traction battery is above a certain level. It is thereby possible to prevent the situation in which the traction battery is over-rated in a multiplicity of vehicles in order to protect just some vehicles against unwanted and anomalous battery loads that may result in a premature deterioration of the battery system.

If there is a requirement for a more powerful battery system, for example a battery system having a higher capacity, higher charging and/or discharging current or the like, embodiments of the disclosure include an existing battery system configured to be retrofitted in a modular manner with the supplementary traction battery.

The supplementary traction battery, like the traction battery, serves to supply at least one electrical drive means such as a traction motor or electric machine of the motor vehicle with electrical energy. Furthermore, the traction battery and/or the supplementary traction battery may also be used to supply other electrical systems of the motor vehicle with electrical energy. What is significant, however, is the use of the supplementary traction battery for supplying the electrical drive means of the motor vehicle with electrical energy. The supplementary traction battery may be connected in parallel with the traction battery, or connected to a further input of the set of battery electronics. Alternatively, the supplementary traction battery may be connected in series with the traction battery, in order to maintain a voltage level. The traction battery and the supplementary traction battery preferably have a plurality of battery cells, in particular lithium-ion battery cells.

The set of battery electronics may additionally monitor and control, by open-loop and/or closed-loop control, the operation of the traction battery, and possibly additionally of the supplementary traction battery. In particular, the set of battery electronics may be configured to sense and evaluate at least one operating parameter of the traction battery, and possibly additionally of the supplementary traction battery. Via the input of the set of battery electronics, the traction battery, and possibly additionally the supplementary traction battery, supplies the electrical energy generated by it to the set of battery electronics, which, from the supplied electrical energy, generates and delivers the battery voltage or the battery power/amperage of the battery system. The input of the set of battery electronics to which the traction battery is connected may differ from the further input of the set of battery electronics to which the supplementary traction battery is connected.

According to an advantageous design, the supplementary traction battery has a lesser capacity than the traction battery. The supplementary traction battery can consequently be produced less expensively than the traction battery. Moreover, the supplementary traction battery can consequently be made smaller than the traction battery, such that the supplementary traction battery requires only a smaller structural space.

A further advantageous design provides that the supplementary traction battery and the traction battery are based on the same or different battery cell types. For example, the traction battery may be based on lithium-ion battery cells, while the supplementary traction battery may likewise have lithium-ion battery cells (also, alternatively, lithium-ion cell chemistries or electrode materials) or different electrochemical battery cells.

According to a further advantageous design, the battery system has at least one battery housing, which has at least one receiver for receiving the traction battery, and at least one additional receiver for receiving the supplementary traction battery. The battery housing may initially be installed in the motor vehicle, for example, only together with a primary or main traction battery inserted therein, while the additional receiver for receiving the supplementary traction battery initially remains unoccupied. One or more modular supplementary traction batteries may then be inserted in the battery housing only if it is ascertained that retrofitting with the supplementary traction battery or batteries should be effected in order to ensure a desired battery power of the battery system. As a result, the motor vehicle does not have to carry along the supplementary traction battery that is initially not required, which would negatively affect the fuel consumption of a hybrid electric motor vehicle. At least one of the receivers of the battery housing may be realized in such a manner that it is suitable for receiving and holding the individual battery cells of the traction battery or supplementary traction battery or batteries.

In one or more embodiments, an electrically drivable motor vehicle may include a battery system having a traction battery configured to receive a modular supplemental traction battery as previously described.

The advantages mentioned above with respect to the battery system are correspondingly associated with the electrically drivable motor vehicle. The motor vehicle may be an electric vehicle, or a hybrid electric vehicle, in particular a plug-in hybrid electric vehicle. For at least two vehicle wheels, the motor vehicle may also have a respective electric traction motor, which can be supplied with electrical energy by the battery system having a traction battery configured to receive a modular supplemental traction battery.

According to an advantageous design, the electrically drivable motor vehicle has at least one receiving structural space for a supplementary traction battery. The receiving structural space for a supplementary traction battery may initially remain unoccupied. The supplementary traction battery may then be inserted in the battery housing only if it is ascertained that retrofitting with the supplementary traction battery should be effected in order to ensure a desired battery power of the battery system. As a result, the motor vehicle does not have to carry along the supplementary traction battery that is initially not required, which would negatively affect the fuel consumption of a hybrid electric motor vehicle.

Further advantageous designs are disclosed in the following description of the figures. There are shown:

### BRIEF DESCRIPTION OF THE DRAWINGS

FIG. 1 is a schematic illustration of a representative electrically drivable motor vehicle having a traction battery configured to receive a modular supplemental traction battery connectable in series, and

FIG. 2 is a schematic illustration of another representative electrically drivable motor vehicle having a battery system according to one or more embodiments of the disclosure with a module supplemental traction battery connectable in parallel to a same side of the battery electronics as the primary traction battery.

### DETAILED DESCRIPTION

In the different figures, parts that are the same are in each case denoted by the same reference, for which reason these parts are usually also described only once.

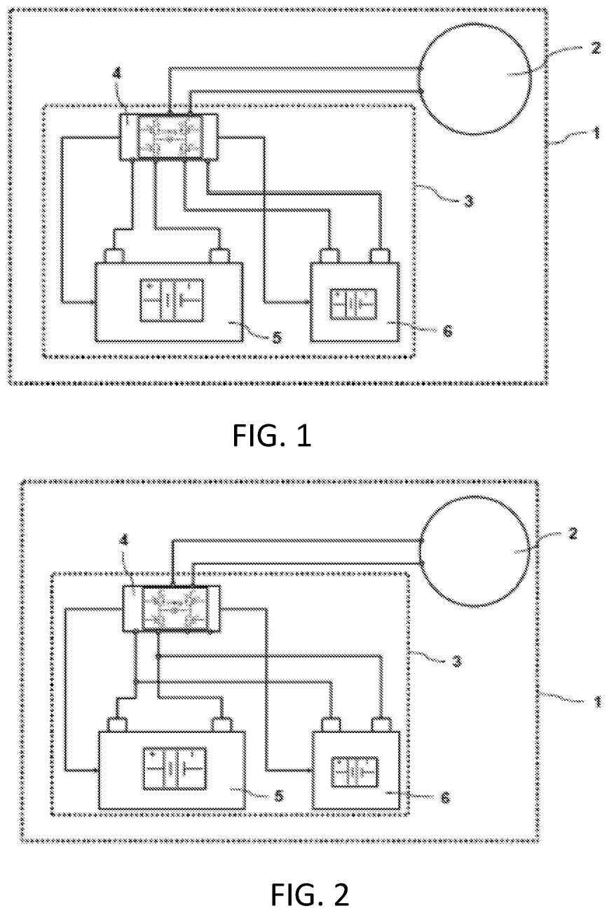

As illustrated in FIG. 1, an electrically drivable motor vehicle 1 has at least one electric traction motor 2, which can be used for recuperation in some operating situations, and also as a generator. The electric machine or traction motor 2 may be connected in circuit on the input side of an inverter, not shown, or a DC/DC converter, not shown. It is possible for the electric drive and the generator to be provided as mutually separate elements.

The motor vehicle 1 additionally has a battery system 3, connected to the electric traction motor 2, for supplying the electric traction motor 2 with electrical energy. The battery system 3 has a set of battery electronics 4, which delivers a battery voltage to the electric traction motor 2. The battery system 3 additionally has a rechargeable traction battery 5, which is connected to an input of the set of battery electronics 4.

Furthermore, the battery system 3 has a modular supplementary traction battery 6, which is connected to a further input of the set of battery electronics 4. The supplementary traction battery 6 has a lesser capacity than the traction battery 5. The supplementary traction battery 6 and the traction battery 5 may be based on the same or different battery cell types. The battery electronics 4 may connect the traction battery 5 and one or more modular supplementary traction batteries in series to boost the voltage of the battery system.

The battery system 3 may further have a battery housing, which has a receiver for receiving the traction battery 5, and an additional receiver for receiving one or more supplementary traction batteries 6. Alternatively, the motor vehicle 1 may have a battery receiving space for a supplementary traction battery in which the supplementary traction battery 6 may be arranged.

FIG. 2 shows a schematic representation of another embodiment of an electrically drivable motor vehicle 1. The motor vehicle 1 differs from the embodiments shown in FIG. 1 in that the supplementary traction battery 6 is connected in parallel with the traction battery 5, and is connected to the same input of the set of battery electronics 4 as the traction battery 5. To avoid repetitions, reference is otherwise made to the above description relating to FIG. 1.

While representative embodiments are described above, it is not intended that these embodiments describe all possible forms of the claimed subject matter. The words used in the specification are words of description rather than limitation, and it is understood that various changes may be made without departing from the spirit and scope of the claimed subject matter. Additionally, the features of various implementing embodiments may be combined to form further embodiments that may not be explicitly described or illustrated.

What is claimed is:

1. A vehicle comprising:
a traction motor;
a traction battery having a traction battery voltage and a traction battery capacity and configured to power the traction motor; and
battery electronics having a first input configured to connect to the traction battery, wherein the traction battery is configured to couple to a modular supplementary traction battery having a supplemental capacity less than the traction battery capacity.

2. The vehicle of claim 1 further comprising a modular supplementary traction battery connected in parallel with the traction battery to supplement the traction battery capacity.

3. The vehicle of claim 1 further comprising a modular supplementary traction battery connected in series with the traction battery to increase the traction battery voltage.

4. The vehicle of claim 1 wherein the traction battery and the modular supplementary traction battery comprise lithium-ion batteries.

5. The vehicle of claim 1 wherein the modular supplementary traction battery is connected to the first input of the battery electronics.

6. The vehicle of claim 1 wherein the modular supplementary traction battery is directly connected to outputs of the traction battery.

7. The vehicle of claim 1 wherein the vehicle further comprises a battery housing having a first compartment configured to receive the traction battery and a second compartment configured to receive the modular supplementary traction battery.

8. A vehicle comprising:
an electric machine;
a traction battery configured to power the electric machine and having a traction battery voltage and a traction battery capacity;
battery electronics configured to connect to the traction battery and the electric machine; and
a housing configured to receive the traction battery and to receive a supplementary traction battery having a supplementary battery capacity less than the traction battery capacity.

9. The vehicle of claim 8 further comprising a supplementary traction battery positioned within the housing.

10. The vehicle of claim 9 wherein the battery electronics comprises a first input connected to the traction battery and the supplementary traction battery.

11. The vehicle of claim 9 wherein the supplementary traction battery is connected in parallel with the traction battery.

12. The vehicle of claim 9 wherein the supplementary traction battery is connected in series with the traction battery.

13. The vehicle of claim 9 wherein the supplementary traction battery is directly connected to outputs of the traction battery.

14. The vehicle of claim 8 wherein the housing comprises a first compartment configured to receive the traction battery, and a second compartment configured to receive the supplementary traction battery.

15. A vehicle comprising:
a traction battery having a first charge capacity;
a supplementary traction battery having a second charge capacity less than the first charge capacity;
a traction motor;
battery electronics connecting the traction motor to the traction battery and the supplemental traction battery; and
a traction battery housing having a main compartment configured to receive the traction battery and at least one supplemental compartment configured to receive the supplementary traction battery wherein the supplementary traction battery is separately removable from the vehicle relative to the traction battery.

16. The vehicle of claim 15 wherein the supplementary traction battery is connected in series with the traction battery.

17. The vehicle of claim 15 wherein the supplementary traction battery is connected in parallel with the traction battery.
